(19) United States
(12) Patent Application Publication
(10) Pub. No.: US 2024/0221076 A1
(43) Pub. Date: Jul. 4, 2024

(54) DETERMINING IMPLIED VOLATILITY FOR CRYPTOASSET DERIVATIVES

(71) Applicant: Lukka, Inc., Naples, FL (US)

(72) Inventor: Shangwen Wang, New York, NY (US)

(21) Appl. No.: 18/220,635

(22) Filed: Jul. 11, 2023

Related U.S. Application Data
(60) Provisional application No. 63/436,266, filed on Dec. 30, 2022.

(51) Int. Cl. G06Q 40/04; G06Q 30/0201

(52) U.S. Cl. CPC G06Q 40/04; G06Q 30/0206

(57) ABSTRACT

An example method of computing implied volatilities for cryptoasset options includes the operations of: receiving input data comprising at least one of: transaction data characterizing a trade in an option of a specified cryptoasset or a quote for the option of the specified cryptoasset, wherein the input data comprises an identifier of an underlying asset, a type of the option, an expiration time of the option, an as-of time of the input data, and a price of the option; estimating a future price for the expiration time of the option; determining a risk-free interest rate associated with the expiration time of the option and the as-of time of the input data; determining a spot price of the underlying asset at the as-of time of the input data; and computing, based on the input data, the future price, the risk-free interest rate, and the spot price, an implied volatility of a price of the option.

### REFERENCE TO RELATED APPLICATIONS

This application claims the priority benefit of U.S. Provisional Patent Application No. 63/436,266, filed Dec. 30, 2022, the entirety of which is incorporated herein by reference.

### TECHNICAL FIELD

The present disclosure is generally related to computing systems, and more specifically relates to methods and systems for determining implied volatility for cryptoasset derivatives.

### BACKGROUND

Cryptoassets are digital assets that use cryptographic techniques to generate a medium to be exchanged in public and/or private exchanges and to validate exchange transactions. Examples of cryptoassets include cryptocurrencies, utility coins, and security tokens.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example distributed computing system 100 operating in accordance with aspects of the present disclosure;

FIG. 2A schematically illustrates an example workflow of computing trade-level cryptoasset implied volatilities by a computing system operating in accordance with aspects of the present disclosure;

FIG. 2B is an illustration of example operations performed by an automated system that is capable of constructing aggregated implied volatility surfaces, in accordance with aspects of the present disclosure;

FIG. 3 schematically illustrates an example structure of a normalized transaction record utilized by systems and methods of the present disclosure;

FIG. 4 illustrates an example of generation of an implied volatility curve for a tenor, in accordance with aspects of the present disclosure;

FIG. 5 schematically illustrates an example data structure employed for pricing data synchronization, in accordance with aspects of the present disclosure;

FIG. 6 illustrates an example of an aggregation of implied volatilities across multiple exchanges, in accordance with aspects of the present disclosure;

FIG. 7 illustrates an example of domain translation of implied volatility surfaces from the strike price-tenor space to delta-tenor space, in accordance with aspects of the present disclosure;

FIG. 8A schematically illustrates an example table of volatility over fixed tenors and relative strikes for a subset of an implied volatility surface generated by systems and methods of the present disclosure;

FIG. 8B schematically illustrates an example table of volatility over fixed tenors and deltas for a subset of the surface of an implied volatility surface generated by systems and methods of the present disclosure;

FIG. 8C schematically illustrates an example table of Risk-Reversal (RR) over fixed tenors generated by systems and methods of the present disclosure;

FIG. 8D schematically illustrates an example table of Butterfly (Fly) over fixed tenors generated by systems and methods of the present disclosure;

FIG. 9 schematically illustrates exponentially decaying values with varying decay parameters, utilized by systems and methods of the present disclosure;

FIG. 10 schematically illustrates the stochastic volatility inspired (SVI) fitted curve output over the weighted implied volatilities from multiple exchanges, generated by systems and methods of the present disclosure;

FIG. 11 is a flowchart of a method of computing implied volatilities for cryptoasset options, in accordance with one or more aspects of the present disclosure;

FIG. 12 is a flowchart of a method of managing a pricing data structure, in accordance with one or more aspects of the present disclosure;

FIG. 13 depicts a block diagram of an example computing system operating in accordance with the examples of the present disclosure.

### DETAILED DESCRIPTION

Described herein are systems and methods for determining implied volatility for cryptoasset derivatives.

Volatility is a statistical measure of the dispersion of asset price movements over time. Implied volatilities of a cryptoasset are forward-looking estimates of future volatilities of the cryptoasset that reflect market expectations on the future movements of the price of the cryptoasset.

Implied volatilities are important inputs for cryptoasset derivatives pricing, valuation, portfolio and risk management. Although historical volatilities may be easily calculated, the market view of a forward-looking volatility of a given cryptoasset requires aggregation of information across exchanges, since trading of cryptoassets and related instruments may be significantly fragmented across multiple exchanges. Accordingly, reliability of information provided by an individual exchange may vary from high volume exchanges to low volume exchanges. Thus, the information needs to be aggregated across exchanges in order to create a representative view of the cryptoassets' derivatives market. The weighting scheme for aggregation is a signal-to-noise enhancement, delegating more weight to those exchanges with more information content. The aggregation simulates a smoothed signal extractor diminishing the effects of outliers without dropping data.

Aspects of the present disclosure address the above-noted and other deficiencies by providing technology that aggregates cryptoassets derivative trading information across multiple exchanges. The systems and methods of the present disclosure compute implied volatilities from traded prices of the associated option contracts based on a consistent reference data definition, thus ensuring consistent and accurate representations and calculations.

In particular, the systems and methods of the present disclosure utilize, for a specific exchange and a cryptoasset, a list of the associated derivatives and related information defined in the standardized derivatives reference data in order to apply derivative traded prices for implied volatility calculation. The implied volatilities may then be computed for every traded price of a specified set of cryptoasset options in order to ensure consistency and continuity across exchanges. These trade level implied volatilities are used as inputs into the implied volatility surface construction, the standardization of implied volatility across exchanges, and the aggregation of market implied volatility across cryptoassets.

In an illustrative example, a computing system implementing the method receives trade data characterizing a reported trade in a derivative instrument (e.g., option) of a specified cryptoasset. In some implementations, quote data reported by exchanges and/or other authoritative sources may be utilized by the systems and methods of the present disclosure in addition to (or instead of) trade data. Thus, unless specifically noted otherwise, any reference herein to trade data or transaction data should be interpreted as data that includes trade and/or quote data.

The trade data may include an identifier of the underlying cryptoasset, a type of the option, an expiration time of the option, an as-of time (i.e., the effective time of the trade), and a price of the option. “Time” herein refers to a data item identifying a calendar date and further identifying a time of the day within the identified date.

The trade data may be received from one or more exchanges, e.g., via respective real-time data feeds. If no futures data with respect to the specified cryptoasset is available for the expiration time of the option, the computing system may determine the future price by interpolating the future prices of two or more futures having their respective expiration times closest to the expiration time of the option. The computing system then determines a risk-free interest rate associated with the expiration time of the option and the as-of time. In various implementations, the computing system may use an external input or utilize a pre-computed reference implied rate. The computing system then determines the spot price of the underlying asset at the as-of time. In various implementations, the computing system may use an external input or utilize previously stored reference data.

Based on the above-described input values, reference data, and computed values (e.g., the trade data, the computed future price, the risk-free interest rate, and the spot price), the computing system may then determine the implied volatility of the price of the option. In an illustrative example, the computing system may numerically solve a system of equations linking the volatility σ(t) to the computed future price, the risk-free interest rate, and the spot price and certain other variables and parameters, as described in more detail herein below.

In some implementations, based on the computed implied volatilities, the computing system may generate a fitted implied volatility smile curve as a function of options' moneyness capturing the volatility skewness of the underlying asset. The computing system may further generate a fitted implied volatility surface as a function over a grid of fixed tenors term structure and moneyness, beyond the standardized option contracts schedules provided by the exchanges, as described in more detail herein below.

In various implementations, the computed implied volatilities and generated volatility surfaces may be utilized in a wide range of applications, including derivative pricing, portfolio and risk management, trading, and quantitative research.

In an illustrative example, the implied volatility surface data generated by systems and methods of the present disclosure may be used for pricing of cryptoasset derivatives with any specified time to expiry and structured products with uncertain future payoffs. In another illustrative example, the implied volatility surface data generated by systems and methods of the present disclosure may be used in portfolio and risk management for assessing the forward-looking profit-and-loss distributions of cryptoasset portfolios. In another illustrative example, the implied volatility surface data generated by systems and methods of the present disclosure may be used for quantitative research.

Thus, the systems and methods described herein improve the accuracy, reliability, and efficiency of cryptoasset-related computations.

The systems and methods described herein may be implemented by hardware (e.g., general purpose and/or specialized processing devices, and/or other devices and associated circuitry), software (e.g., instructions executable by a processing device), or a combination thereof. In an illustrative example, a computing system implementing the systems and methods of the present disclosure may be provided by one or more virtual or physical execution environments (e.g., virtual or physical servers)

Various aspects of the above referenced methods and systems are described in details herein below by way of examples, rather than by way of limitation.

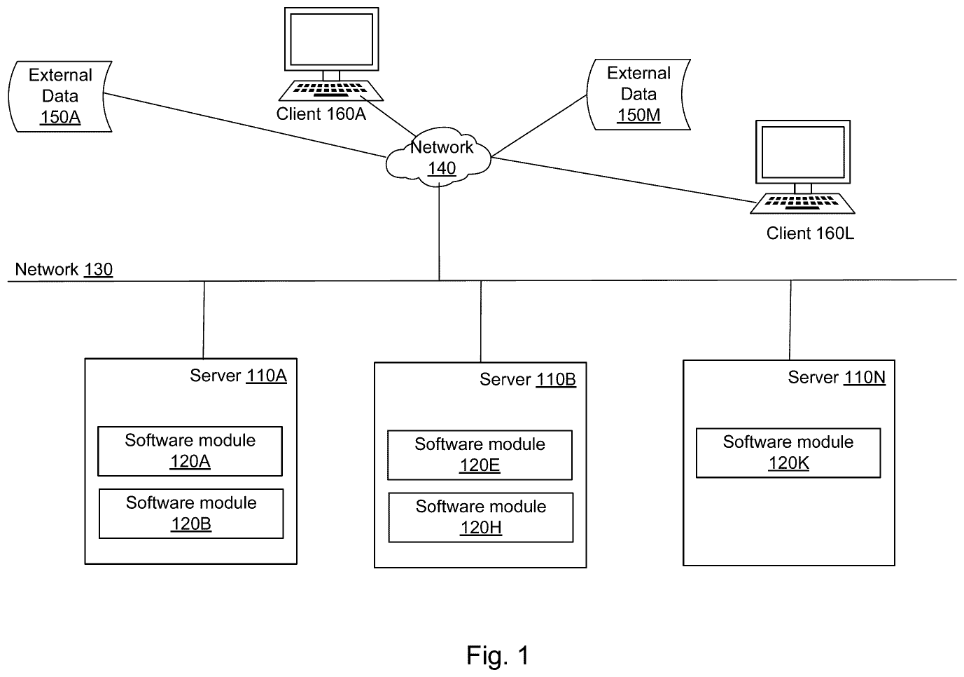

FIG. 1 schematically illustrates an example distributed computing system 100 operating in accordance with aspects of the present disclosure. The computing system 100 may include one or more servers 110A-110N which implement respective virtual or physical execution environments running one or more software modules 120A-120K implementing the methods described herein. “Software module” herein refers to one or more files containing executable code and its dependencies, such as system and application libraries, application programming interface (API) definitions, media files, graphical user interface (GUI) definition files, etc.

In some implementations, the servers 110A-110N may be interconnected by one or more networks 130, which may include public and/or private networks. In some implementations, the servers 110A-110N may reside within a public or a private cloud. In some implementations, the servers 110A-110N may include one or more clusters of compute nodes, one or more storage nodes, and/or one or more presentation nodes.

In some implementations, the servers 110A-110N may be interconnected, via one or more external networks 140, to one or more external data feeds 150A-150M. In an illustrative example, the external data feeds 150A-150M may provide, in real-time and/or in batch mode, trading data from multiple cryptoasset exchanges and/or reference data to be utilized in computing the implied volatilities, as described in more detail herein below.

The servers 110A-110N may be accessible, via one or more networks 130 and/or 140, by client devices 160-160L, which may be represented, e.g., by terminals, personal computers, mobile computing devices, etc. The client devices 160-160K may be equipped with respective graphical user interfaces (GUIs). The input data received through the GUI(s) may be utilized for building a query to be forwarded to one or more servers 110A-110N. The response data returned by a server 110 in response to the query may be visually rendered by the requesting client device 160 in the form of text, tables, graphs, diagrams, etc.

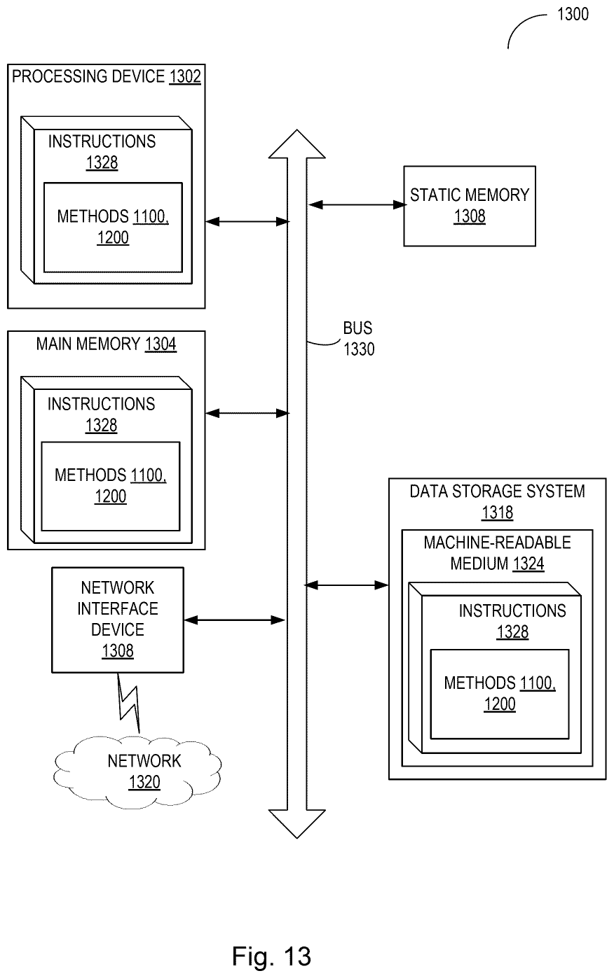

In some implementations, the servers 110A-110N may be implemented by one or more computing systems 1300 of FIG. 13.

Various auxiliary components, such as firewalls, routers, switches, consoles, etc., are omitted from FIG. 1 for clarity and conciseness.

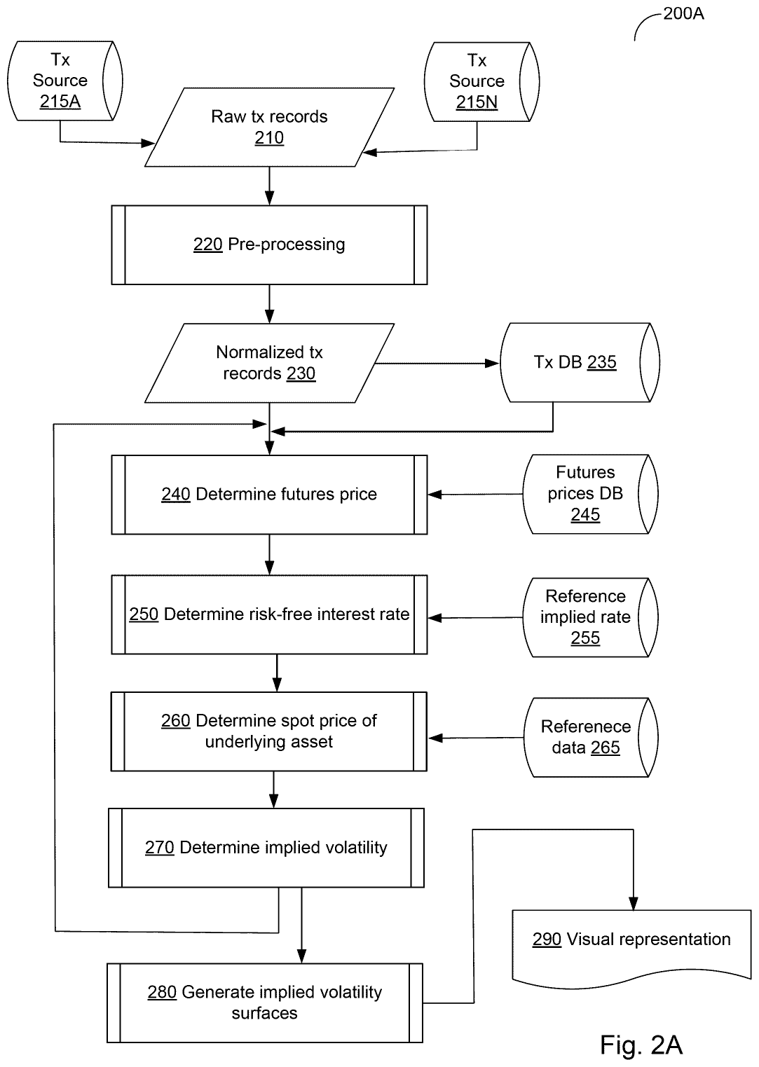

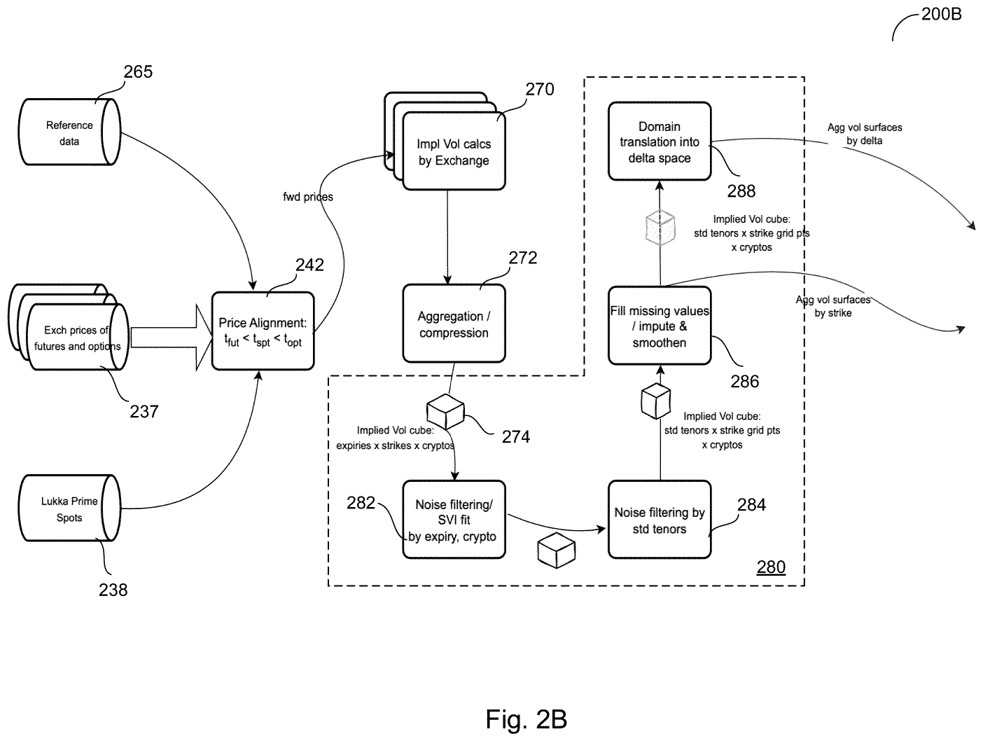

FIG. 2A schematically illustrates an example workflow 200A of computing trade-level implied volatilities in accordance with aspects of the present disclosure. Workflow 200A and/or each of its individual functions, routines, subroutines, or operations may be implemented by one or more software modules running in one or more virtual or physical execution environments (e.g., virtual or physical servers) or collocated with other servers or applications. The computing system performing workflow 200B may include various processing, memory and storage components that collect and process cryptoasset's pricing data to generate forward-looking implied volatility information. In an illustrative example, workflow 200A may be implemented by the example distributed computing system 100 of FIG. 1.

As schematically illustrated by FIG. 2A, the computing system implementing the workflow 200A may continuously or periodically receive, from one or more trade (transaction, Tx) data sources 215A-215N, batches of one or more transaction records 210 characterizing cryptoasset trades performed by one or more cryptoasset trading platforms. In an illustrative example, each transaction record may reflect an option trade and thus may include information identifying the transaction time, the type of the option, the expiration time of the option, the price of the option, and the underlying cryptoasset or index.

In various implementations, a transaction record 210 may fully identify the parties to the transaction, pseudonymize the parties, or anonymize the parties. In an illustrative example, the parties to a transaction may be identified by their respective account identifiers. In another illustrative example, the transaction record may reference the parties to a transaction by their pseudonyms; a pseudonym associated with a party may be generated from a party identifying information by an irreversible transformation, such that each party identifier is transformed into a corresponding pseudonym, thus exclusively associating the pseudonym with the party identifying information. In another illustrative example, the parties to a transaction may be anonymized, i.e., the transaction record may contain no party identifying information.

While identification of the parties to the transaction is not required for determination of the implied volatilities by systems and methods operating in accordance with aspects of the present disclosure, the party identifying information or pseudonyms may in some implementations be utilized for identifying intra-group transactions performed between a group of related parties; such transactions may be excluded from consideration and/or given smaller weights as compared to arm-length transactions.

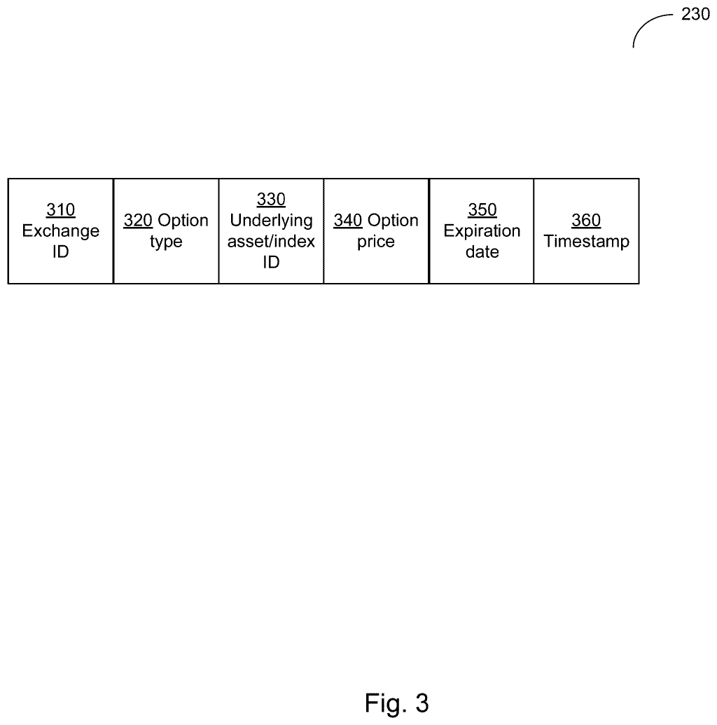

The computing system may perform a pre-processing operation 220, which translates the raw transaction records 210 into a set of normalized transaction records 230 conforming to a chosen format. Each normalized transaction record 230 may reflect an option trade. As schematically illustrated by FIG. 3, each normalized transaction record 230 may include an identifier 310 of the exchange that has executed the transaction, the option type 320, an identifier 330 of the underlying cryptoasset or index, the price of the option 340, the expiration time of the option 350, and the timestamp 360.

In some implementations, translating the raw transaction records 210 into normalized transaction records 230 may further involve validating and normalizing asset identifiers (e.g., by comparing an asset identifier specified by a transaction record to a reference list of asset identifiers). In an illustrative example, translating the raw transaction records 210 into normalized transaction records 230 may further involve validating and/or modifying various other transaction record fields (e.g., as described in more detail herein below). In another illustrative example, translating the raw transaction records 210 into normalized transaction records 230 may further involve appending, to the normalized transaction record, a weight coefficient characterizing the exchange that has provided the original raw transaction record and/or other transaction attributes specified by certain transaction record fields, as described in more detail herein below. In another illustrative example, translating the raw transaction records 210 into normalized transaction records 230 may further involve filtering the raw transaction records 210, by discarding the raw transaction records 210 that fail to satisfy one or more filtering conditions that may be defined based on one or more transaction attributes specified by certain transaction record fields, as described in more detail herein below.

The resulting normalized set(s) of transaction records 230 associated with a specified cryptoasset may be stored in volatile and/or non-volatile memory. In some implementations, a separate set of normalized transaction records may be stored in the transaction database 225 for each option type of a given cryptoasset or index.

In some implementations, at least a subset of the normalized transaction records 230 filtered by cryptoasset identifier, option type, and/or other parameters may be stored in a data structure that preserves a chronological order of their respective timestamps, such as a queue or a linked list, each element of which includes at least a subset of the fields of the example transaction record 300 of FIG. 3. In some implementations, the data structure may be sorted in the chronological order (e.g., ascending or descending) of the timestamps associated with its elements.

The computing system may process each normalized transaction record 230 by performing operations 240-270. In some implementations, the incoming transaction records are processed in real-time or near real-time. Alternatively, the normalized transaction records 230 may be retrieved from the transaction database 235 asynchronously with respect to receiving and pre-processing the raw transaction records 210.

In some implementations, the computing system may selectively retrieve the normalized transaction records 230 based on logical conditions specifying values, ranges, or relationships of one or more transaction parameters, which allows caching certain intermediate results and/or reference data in subsequent computations. In some implementations, the reference data 265 includes quotes for various cryptoassets provided by one or more quote sources. In some implementations, the reference data 265, including the quote data, may be pre-processed and/or cached in a manner similar to pre-processing and caching of the transaction data (e.g., raw transactions records 210).

In some implementations, one set of processing threads may receive and pre-process the raw transaction records 210, while another set of processing threads may perform the transaction processing operations 240-270. “Processing thread” herein shall refer to a sequence of executable instructions that is executed by a physical or virtual processor in a separate execution context or in an execution context which is at least partially shared with other processing threads. The “execution context” herein shall refer to the processor state, the memory state, and the input/output (I/O) device state. The number of threads in each of the two sets of processing threads may be pre-defined or dynamically determined based on one or more operational parameters, such as the incoming transaction rate, the typical transaction processing time, the availability of hardware resources, etc. In an illustrative example, responsive to detecting a surge of the incoming transaction rate of receiving the raw transaction records 210 (e.g., an increase by at least a predefined threshold number of incoming transactions per unit of time that has been observed by at least a predefined period of time), the computing system may increase the number of processing threads that perform the transaction processing operations 240-270.

Processing a normalized transaction record may involve determining the futures price of the underlying asset for the option expiration time specified by the transaction record (operation 240). In an illustrative example, responsive to failing to locate the requisite futures price in one or more reference future prices databases 245, the computing system may estimate the requisite futures price, e.g., by interpolating the prices of two or more available prices of instruments with maturity times that precede and/or follow the option expiration time specified by the transaction record being processed.

Specifically, if at time t (as-of time) there is a futures maturing at T₁ before T (with a price F(t;T₁)) and a futures maturing at T₂ after T (with a price F(t;T₂)), then the price of the futures at as-of time and maturing at T may be interpolated as follows:

$$F ( t ; T ) = ( \frac{{T}_{2} - T}{{T}_{2} - {T}_{1}} ) F ( t ; {T}_{1} ) + ( \frac{T - {T}_{1}}{{T}_{2} - {T}_{1}} ) F ( t ; {T}_{2} ) , where {T}_{1} < T < {T}_{2} .$$

If one of the instruments, e.g., the first futures, is not available, the system may use the spot price S(t) as the price of that first instrument:

$$F ( t ; T ) = ( \frac{{T}_{2} - T}{{T}_{2} - t} ) S ( t ) + ( \frac{T - t}{{T}_{2} - t} ) F ( t ; {T}_{2} ) , where t < T < {T}_{2} .$$

Referring again to FIG. 2A, at operation 250, the computing system may determine the risk-free interest rate associated with the expiration time of the option and the as-of time. In an illustrative example, the risk-free interest rate is the maximum interest rate at which one can borrow at time t and still break even, if the future contract is exercised at maturity time T.

In various implementations, the computing system may use an external input or utilize a pre-computed reference implied rate 255. In some implementations, the risk-free interest rate may be assumed to be 0.

The computing system may then determine (operation 260) the spot price of the underlying asset or index at the as-of times of the transaction being processed. In various implementations, the computing system may use an external input or utilize previously stored reference data 265.

Based on the above-described input values, reference data, and computed values (e.g., the trade data, the computed future price, the risk-free interest rate, and the spot price), the computing system may then determine (operation 270) the implied volatility of the price of the option.

In an illustrative example, the computing system may numerically solve the below system of equations linking the volatility σ(t) to the computed future price, the risk-free interest rate, and the spot price and certain other variables and parameters for the call option:

$$C ( F , t ; T ) = {e}^{- r ( T - t )} ( N ( {d}_{1} ) F ( t ; T ) - N ( {d}_{2} ) K )$$

Similarly, for a put option:

$$P ( F , t ; T ) = {e}^{- r ( T - t )} ( - N ( - {d}_{1} ) F ( t ; T ) + N ( - {d}_{2} ) K )$$

$$\begin{matrix}{d}_{1} = \frac{ln ( \frac{F ( t ; T )}{K} ) + ( r + \frac{{σ ( t )}^{2}}{2} ) ( T - t )}{σ ( t ) \sqrt{T - t}} \\ {d}_{2} = {d}_{1} - σ ( t ) \sqrt{T - t} = \frac{ln ( \frac{F ( t ; T )}{K} ) + ( r - \frac{{σ ( t )}^{2}}{2} ) ( T - t )}{σ ( t ) \sqrt{T - t}}\end{matrix}$$

where T is option expiration time. For example, a quarterly option may expire on the last Friday of each calendar quarter at 08:00:00 UTC;
t is the as-of time. Note that (T−t) is in the unit of years, so that the implied volatility measure is annualized;
C(F,t;T) is the call option price at the as-of time;
P(F,t;T) is the put option price at the as-of time;
F(t;T) is the futures price at the as-of time. The futures contract is written on the same underlying asset and maturing at the same time as the corresponding option's expiration time. In general, F(t;T)=S(t)e^{r(T-t)} is related to the expected value of what the underlying asset's future price will be at maturity time T. Therefore, utilizing futures price information can capture the market expectation of future risk-free interest rates and avoid arbitrage;
K is the option strike price;
r is the risk-free interest rate;
σ(t) is the annualized implied volatility to be solved;
S(t) is the spot price of the underlying asset or index at the as-of time;
N(d) is the integrated normal distribution giving the probability that a random draw from the normal distribution will be less than d; the symmetry of the normal distribution implies that N(−d)=1−N(d); N(d₁) can be interpreted as the conditional probability of the future price to be above the strike price; and N(d₂) is the unconditional probability of a call option being in-the-money when the future price will be above the strike price.

Referring again to FIG. 2A, at operation 280, the computing system, based on the computed implied volatilities, generates a fitted implied volatility smile curve as a function of options' moneyness capturing the volatility skewness of the underlying asset. The computing system may further generate a fitted implied volatility surface as a function over a grid of fixed tenors term structure and moneyness, beyond the standardized option contracts schedules provided by the exchanges.

For a specific exchange and underlying asset at a certain as-of time, the system may first fit the implied volatility smile curve over strikes for each upcoming expiration time based on the derivatives reference data. The function of the implied volatility smile curve is based on stochastic volatility inspired (SVI) parameterization. The SVI function is independent of the time to expiration.

The system may then calibrate five function parameters {a,b,ρ,m,σ} that minimize the sum of squared errors between the fitted parametric volatility curve and OTM options' implied volatilities.

For a given parameter set {a,b,ρ,m,σ}, the SVI parameterization of implied volatility smile curve at any given k (over a certain range of k) is:

$${σ}_{SVI , t} ( k ) = \sqrt{( a + b ( ρ ( k - m ) + \sqrt{{( k - m )}^{2} + {σ}^{2} )} ) ( \frac{1}{T - t} )}$$

where

$$k = ln ( \frac{K}{F ( t ; T )} )$$

represents the moneyness across strike prices; k=0 for the options that are at-the-money (ATM), e.g., those whose price is equal to that of the strike price;
(T−t) is in the unit of years. T is expiration time and t is the as-of time;
a∈R is like the intercept determining a vertical translation of the smile curve. Increasing a increases the overall level of variance in the positive direction;
b≥0 is the angle between the put and call wing. Increasing b increases the slopes of both the put and call wings, reducing the angle and tightening the smile;
   |ρ|<1 determined a counter-clockwise rotation of the smile curve. Increasing ρ decreases (increases) the slope of the left (right) wing. The cases ρ=1 and ρ=−1 are excluded, where the volatility smile is respectively strictly increasing and decreasing;
m∈R is like the volatility data calibrated mean of strikes determining a horizontal translation of the smile curve. Increasing m shifts the smile curve to the right in the positive direction;
σ>0 is like the volatility data calibrated standard deviation of strikes determining how smooth the vertex is. Increasing σ reduces the ATM curvature of the smile. The case σ=0 is excluded, which corresponds to a linear smile;

The function σ_{SVI}(k) is (strictly) convex on the whole real line, i.e., it increases linearly with |k| for k very positive or very negative, such that the more out-of-the-money an option is, the more volatility it has;

The condition a+bσ\sqrt{1−ρ²}≥0 ensures that σ_{SVI}(k)≥0 for all k∈R;

Before the calibration, the system may establish the following parameters and apply the following data filtering rules:
At any as-of time for a cryptoasset from an exchange, the system sets the look-back window (e.g., to 48 hours) to collect the most recent trade-level implied volatilities prior to as-of time for all strikes and expiries, thus providing more data to work with for SVI fitting;
Only out-of-the-money (OTM) options may be selected (as they are more liquid than far ITM options) for the fitting purpose: puts with strike K<K_{ATM} and calls with strike K>K_{ATM}. The at-the-money (ATM) strike K_{ATM} is the strike closest to the underlying asset's spot price at the as-of time. The system may then sort the OTM options' implied volatilities by strikes in ascending order preparing for fitting a curve over strikes;
The tenor range of the implied volatility surface for each cryptoasset based on options offered by an exchange. For example, if an exchange offers up to 4th quarterly options, then we will estimate the implied volatility surface for the 1 Y tenor even when longest-term options' time to expiries are less than 1 year;
Determine the minimum of overall observed trade-level implied volatilities, and set the entire fitted implied volatility surface lower bound (LB) for all tenors and for both by strike and by delta:

LB=0.8*(minimum of overall trade-level implied volatilities)>0;
Set the implied volatility surface maximum upper bound (MUB) to a predefined value (e.g., 10).
Determine the maximum of overall observed trade-level OTM implied volatilities, and set the entire fitted implied volatility surface upper bound (UB) for all tenors and for both by strike and by delta:

UB=min(2*(max of overall trade-level (OTM) implied volatilities expiring longer than 2 days), MUB).

In order to ensure a surface with a convex curve for each tenor and within a reasonable range of magnitudes, the system may implement the following constrained optimization by choosing the parameter set {a,b,ρ,m,σ} to minimize the sum of squared errors between the fitted parametric volatility curve and trade-level OTM options' implied volatilities. The fitting is done on the implied variance space.

$$min {\sum }_{i = 1}^{N} {( {σ}_{SVI , T - t}^{2} ( {k}_{i} ) - {σ}_{trade , T - t}^{2} ( {k}_{i} ) )}^{2}$$

subject to LB≤σ_{SVI}(k)≤UB, so that calibrated implied volatilities exceed the surface lower and upper bounds (as defined before calibration) will be penalized;
b≥0 to enforce a convex curve around the vertex near ATM region;
   |ρ|<1 to restrict the range of correlation between changes in the underlying asset prices and changes in the instantaneous variance;
   |m|<1 to limit the range of horizontal translation of the smile curve shifting away from the ATM region; and
σ>0 to ensure the positive curvature of the smile curve.

After the calibration, those fitted implied volatilities above the UB will be set to not-a-number (NAN) value.

Referring again to FIG. 2A, at operation 290, the computing system generates visual representations of the computed implied volatilities and generated implied volatility surfaces. In various implementations, the visual representations may be in the form of tables, 2-D or 3-D plots, diagrams, etc.

FIG. 2B schematically illustrates another example workflow 200B of computing trade-level implied volatilities in accordance with aspects of the present disclosure. Workflow 200B and/or each of its individual functions, routines, subroutines, or operations may be implemented by one or more software modules running in one or more virtual or physical execution environments (e.g., virtual or physical servers) or collocated with other servers or applications. The computing system performing workflow 200B may include various processing, memory and storage components that collect and process cryptoasset's pricing data to generate forward-looking implied volatility information. In an illustrative example, workflow 200B may be implemented by the example distributed computing system 100 of FIG. 1.

Reference data 265 (which may be stored in the transaction database 235) provides the list of normalized cryptoassets and their associated derivatives from multiple sources and normalizes this information into static data attributes. As noted herein above, the reference data 265 may include trade data and/or quote data provided by one or more exchanges. The normalization may include bringing to a common format derivative acronyms, price formats, currencies types (e.g., converting from cryptoassets prices to fiat currency prices), and/or other records of derivatives. The common format may be a proprietary format. An example of a normalized transaction record of reference data 236 is illustrated in FIG. 3.

Workflow 200B may include aligning and synchronizing (block 242) an option's pricing and time data with the pricing and time data of the underlying cryptoasset, using available prices of futures and options 237. Such aligning and synchronization are important since implied volatility of options is determined (e.g., using the Black '76 model) using both the price, at time t, of an option having expiration date (expiry) T and a price of a futures contract for the same underlying cryptoasset with the same expiry T. The price of the traded futures with precisely the same expiry T, however, may often be unavailable in the database. Correspondingly, alignment performed at block 242 may include finding futures prices with minimal misalignment of simultaneity (differences of expiration date) with the option. More specifically, the alignment ensures that for individual option transactions, the closest underlying cryptoasset's futures prices are obtained and prices of futures with the desired expiration dates are estimated (interpolated) from the prices of two (or more) futures, with a shorter expiry T₁<T and longer maturity T₂>T. When a shorter-expiry futures price is not available, interpolation may include using the as-of time t spot prices 238 of the underlying assets, as described in more detail above.

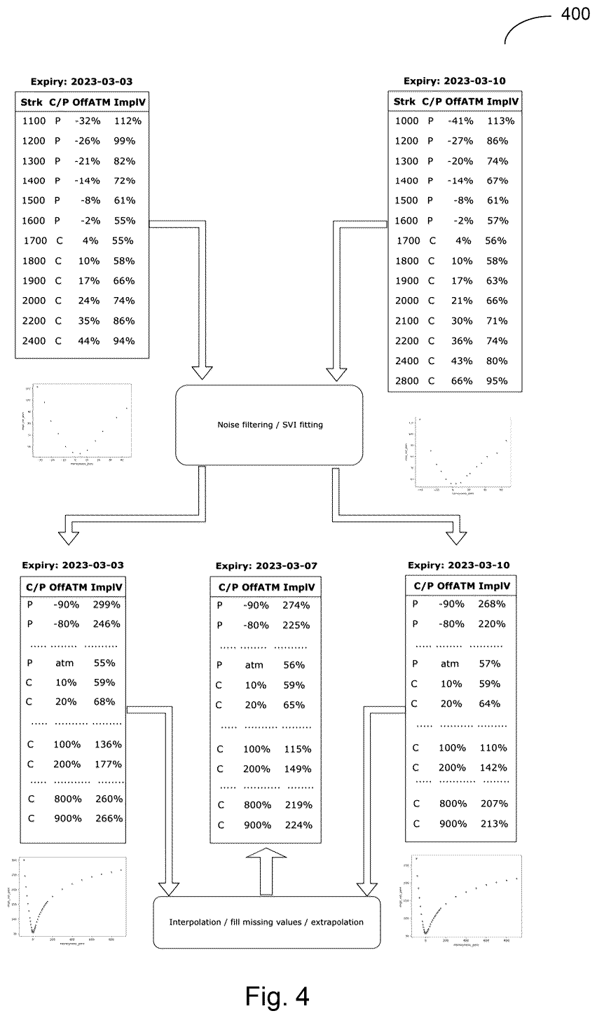

The process of alignment may include: (1) determining a price of the option for a chosen time that is prior to the as-of time for which the implied volatility of the price of the option is being computed, (2) verifying that a timestamp associated with the price of the option tₒₚₜ is later than a timestamp tₛₚₜ associated with a spot price of the underlying cryptoasset for the conversion to fiat price of the option, (3) verifying that the timestamp tₛₚₜ associated with the spot price of the underlying cryptoasset is later than a listed futures timestamp t_{fut}, and (4) determining a forward price of the underlying cryptoasset at the expiration time of the option based on either a price of the futures expiring at the same time, or an interpolated price from two futures having their respective expiration time closest to the expiration time of the option. FIG. 4 illustrates an example of generation of an implied volatility curve 400 for a tenor, in accordance with aspects of the present disclosure.

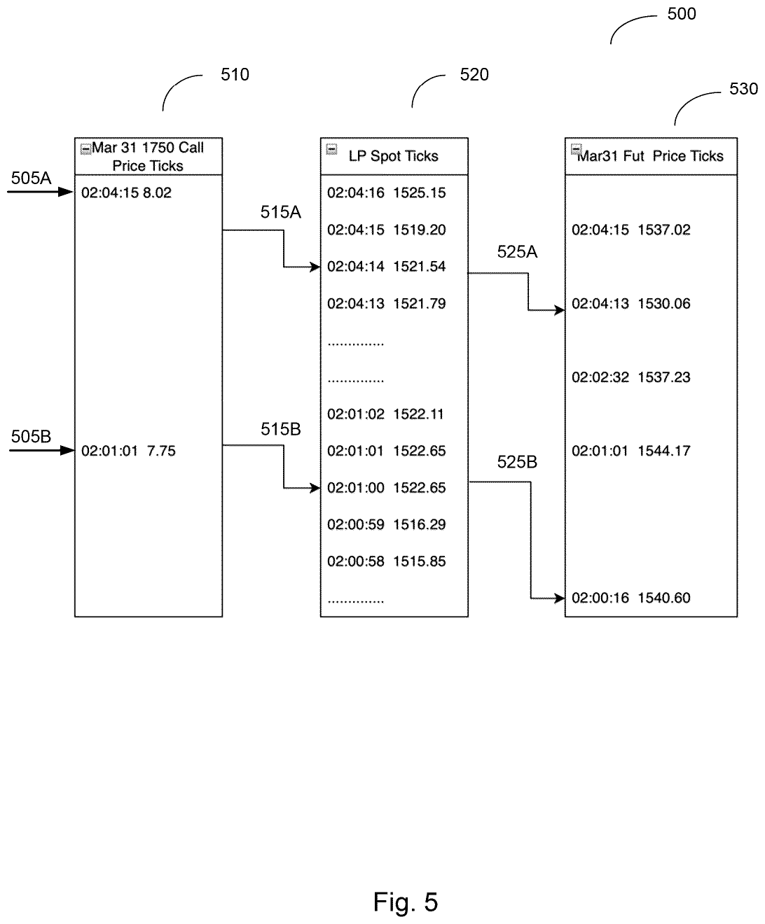

In some implementations, for improving the efficiency of computations, the pricing data synchronization may be facilitated by a data structure that, for a specified underlying cryptoasset, includes three queues, such that each queue, which stores a certain subset of pricing data items that are ordered in the order of their respective timestamps, is associated with a respective pointer, and the pointers are synchronized in a certain order, thus preserving the requisite relationships between the timestamps of the data items retrieved from each of the queues, as schematically illustrated by FIG. 5, which shows an example data structure 500 that may be employed for pricing data synchronization, in accordance with aspects of the present disclosure.

As schematically illustrated by FIG. 5, the example data structure 500 includes, for a specified underlying cryptoasset, the option pricing data queue 510, the underlying cryptoasset spot pricing data queue 520, and the future pricing data queue 530 associated with respective synchronized pointers. In some implementations, the queues may be populated by extracting the pricing data from the normalized transaction database 235, future price database 240, reference data 265, prices of futures and options database 237, and/or spot price database 235. In some implementations, for decreasing the latency associated with the data retrieval, the data structure 500 may at least partially reside in a random access memory (RAM) of the computing system executing the workflows 200A and/or 200B. In some implementations, for decreasing the latency associated with the data retrieval, the data structure 500 may reside in a non-volatile memory of the computing system executing the workflows 200A and/or 200B, and may further at least partially be cached by a memory buffer residing in a random access memory (RAM) of the computing system executing the workflows 200A and/or 200B.

In some implementations, the size of a memory buffer storing a cache of the pricing data structure 500 for a certain underlying cryptoasset may be dynamically adjusted to reflect the trading volume of the underlying cryptoasset over a certain period of time at one or more chosen reference exchanges. In an illustrative example, a predefined number of most extensively traded underlying cryptoassets is chosen for caching their respective pricing data structures 500. The total size of available memory (e.g., random access memory (RAM)) allocated to store the caches may then be split between pricing data structures 500 proportionally to the trading volumes of the respective underlying cryptoassets over a certain period of time at the reference exchanges. The cache memory allocation to the pricing data structures 500 may be dynamically adjusted with a chosen frequency (e.g., once every 24 hours) or responsive to a certain triggering event (e.g., responsive to detecting a spike in the trading volume of a certain underlying cryptoasset).

In some implementations, the data structure 500 may be populated by one or more background execution threads extracting the pricing data from the normalized transaction database 235, future price database 240, reference data 265, prices of futures and options database 237, and/or spot price database 235. In some implementations, the background execution threads populating the data structure 500 may run asynchronously with respect to other execution threads implementing the workflows 200A and/or 200B. In some implementations, in order to improve the efficiency of computations, the number of the background execution threads populating the data structure 500 may be dynamically adjusted (i.e., decreased or increased) based on the number of execution threads servicing incoming requests for performing the implied volatility computations of the workflows 200A and/or 200B.

In an illustrative example, a certain number of the available processing cores of the computing system implementing the workflows 200A and/or 200B may be assigned to a pool of worker execution threads, from which the execution threads servicing incoming requests and the execution threads populating the data structure 500 may be allocated. The number of the execution threads servicing incoming requests for performing the implied volatility computations may then be dynamically adjusted based the rate of incoming requests (e.g., increased in response to the increased rate or incoming requests), which would in turn require the matching adjustment of the number of execution threads populating the data structure 500 (e.g., reducing the number of execution threads populating the data structure 500 in response to the increased rate or incoming requests, in order to re-assign one or more processing cores to run execution threads servicing incoming requests for performing the implied volatility computations).

Referring again to FIG. 5, option pricing data queue 510 may be associated with the option pricing data pointer, which may reference a specific option pricing data item (e.g., 505A, 505B) associated with a corresponding timestamp. The underlying cryptoasset spot pricing data queue 520 may be associated with the cryptoasset spot pricing data pointer, which may reference a specific cryptoasset spot pricing data item (e.g., 515A, 515B) associated with a corresponding timestamp. The future pricing data queue 530 may be associated with the future pricing data pointer, which may reference a specific future pricing data item (e.g., 525A, 525B) associated with a corresponding timestamp.

As noted herein above, the pointers associated with the queues 510, 520, and 530 are synchronized in a certain order, thus preserving the requisite relationships between the timestamps of the data items retrieved from each of the queues. In an illustrative example, based on the specified as-of time for which the implied volatility of the price of the option is being computed, the option pricing data pointer 505A may be set to reference the option pricing data item which has the maximum timestamp among the available option pricing data items whose timestamps precede the as-of time. The cryptoasset spot pricing data pointer 515A and the future pricing data pointer 525A may then be synchronized with the new value of the option pricing data pointer 505A. In particular, the cryptoasset spot pricing data pointer 515A may be set to reference the spot pricing data item which has the maximum timestamp among the available spot pricing data items whose timestamps precede the timestamp of the option pricing data item referenced by the option pricing data pointer 505A. Similarly, the future pricing data pointer 525A may be set to reference the future pricing data item which has the maximum timestamp among the available spot pricing data items whose timestamps precede the timestamp of the spot pricing data item referenced by the spot pricing data pointer 515A. Then, the data items referenced by the pointers 505A, 515A, and 525A may be fed into the implied volatility computation operation 270 of workflows 200A and/or 200B.

In another illustrative example, based on another specified as-of time for which the implied volatility of the price of the option is being computed, the option pricing data pointer 505B may be set to reference the option pricing data item which has the maximum timestamp among the available option pricing data items whose timestamps precede the as-of time. The cryptoasset spot pricing data pointer 515B and the future pricing data pointer 525B may then be synchronized with the new value of the option pricing data pointer 505B. In particular, the cryptoasset spot pricing data pointer 515B may be set to reference the spot pricing data item which has the maximum timestamp among the available spot pricing data items whose timestamps precede the timestamp of the option pricing data item referenced by the option pricing data pointer 505B. Similarly, the future pricing data pointer 525B may be set to reference the future pricing data item which has the maximum timestamp among the available spot pricing data items whose timestamps precede the timestamp of the spot pricing data item referenced by the spot pricing data pointer 515B. Then, the data items referenced by the pointers 505B, 515B, and 525B may be fed into the implied volatility computation operation 270 of workflows 200A and/or 200B.

In some implementations, the pointer synchronization operations may be performed by a dedicated processing thread which is triggered by a request from workflows 200A and/or 200B; the request may specify the as-of time, which may be used as the reference for creating and synchronizing a set of pointers 505, 515, and 525 as described above. In some implementations, the pointers may be protected from being modified by processing threads other than the dedicated processing thread performing the pointer synchronization operations, thus ensuring the consistency of the reference pricing data set that includes the spot pricing data item, the option pricing data item, and the future pricing data item referenced by the respective pointers, and further ensuring the requisite order of the timestamps of the pricing data items forming the reference pricing data set.

Referring again to FIG. 2B, workflow 200B may include processing the option prices and the aligned futures prices to compute the implied volatility for various option pricing records (block 270). Option pricing volatility may be computed separately for different exchanges. At block 272, the implied volatilities for different option strike prices and for different expiration dates may be aggregated across different exchanges. Aggregation generates implied volatility surfaces 274 for cryptoassets covering a target range of strike prices and tenors. The implied volatility surfaces may be viewed as surfaces in a multi-dimensional space, e.g., σ(SP,T−t,Opt), where SP is the strike price (representing moneyness) of a given option Opt with tenor T−t (time to expiry counted from as-of time t).

During aggregation of implied volatilities across multiple exchanges, it is important to effectively differentiate information obtained from these exchanges. This may be achieved by fitting the aggregate implied volatility surfaces 274 using the aggregate trade level implied volatilities. For each tenor and for each moneyness, there are usually more trade level implied volatilities than can be aggregated across exchanges due to the fragmented nature of the cryptoasset ecosystem. Because trade-level implied volatilities of the same moneyness from different exchanges often have different reliability, such trade-level implied volatilities should not be counted equally. In some implementations, time-decayed weighted trade-level implied volatilities may be used to construct the aggregate trade-level implied volatilities for each moneyness and tenor. Subsequently, it is possible to fit the SVI (stochastic volatility inspired) parameterization implied volatility surface over the aggregated trade-level implied volatilities.

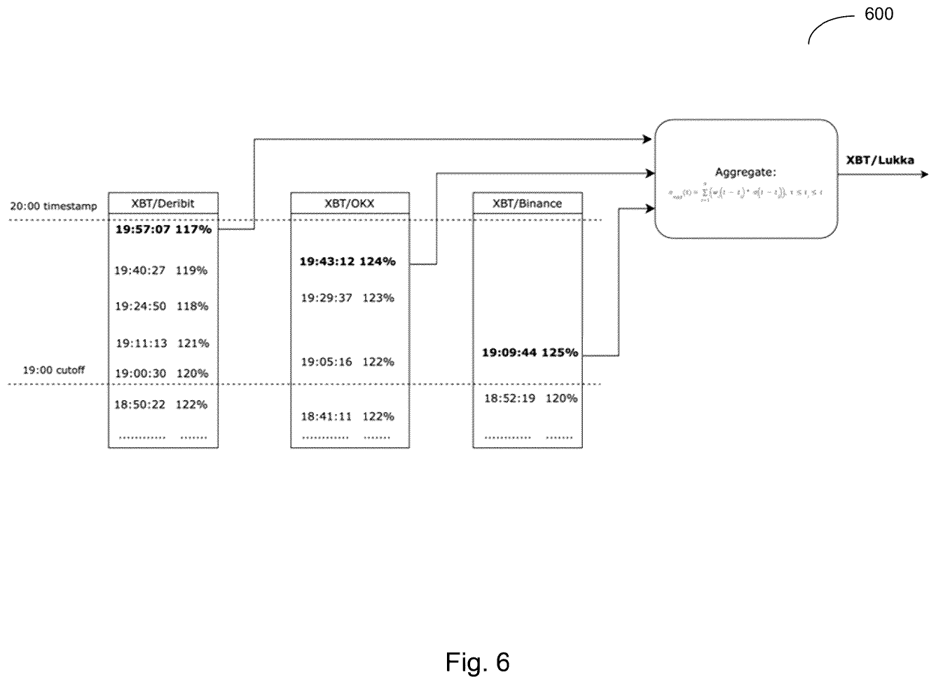

More specifically, the process may be carried out similarly to computation of trade-level implied volatilities but with an additional step of aggregation. For each strike price, the most recent trade-level implied volatilities may be collected from each exchange prior to as-of-time t and the trade-level implied volatility may be aggregated over the exchanges. For each expiration time, the aggregated trade-level implied volatility may be sorted over strike prices and fitted using an SVI curve over the aggregated trade-level implied volatilities. FIG. 6 illustrates an example of an aggregation 600 of implied volatilities across multiple exchanges, in accordance with aspects of the present disclosure.

At block 282, aggregated implied volatilities may be fitted with respect to their dependence on expiration time. Such fitting using a smooth (e.g., SVI) curve eliminates or reduces noise. At block 284, additional fitting may be performed for a grid of tenors.

During generation of implied volatility surfaces, it is important to cover the target range of strike prices and tenors within without incurring ranges of missing values of SP and T−t. In some implementation, filling missing values (block 286) may include (1) computing the implied volatility for each option pricing record, (2) obtaining the implied volatility curve for each tenor by filtering and interpolating implied volatilities from the near and next expiries, (3) forming the implied volatility surface by combining the obtained implied volatility curves of a grid of fixed tenors, and (4) imputing (e.g., by interpolation or extrapolation) the missing values to ensure that each implied volatility surface is covering the target range of strike prices and tenor ranges. The grid of fixed tenors may include a set of prescribed times to expiration, e.g., a set of 1-day, 2-day, 3-day, 1-week, 2-week, 3-week, 1-month, 2-month, 3-month, 6-month, 9-month, 1 year, etc., tenors.

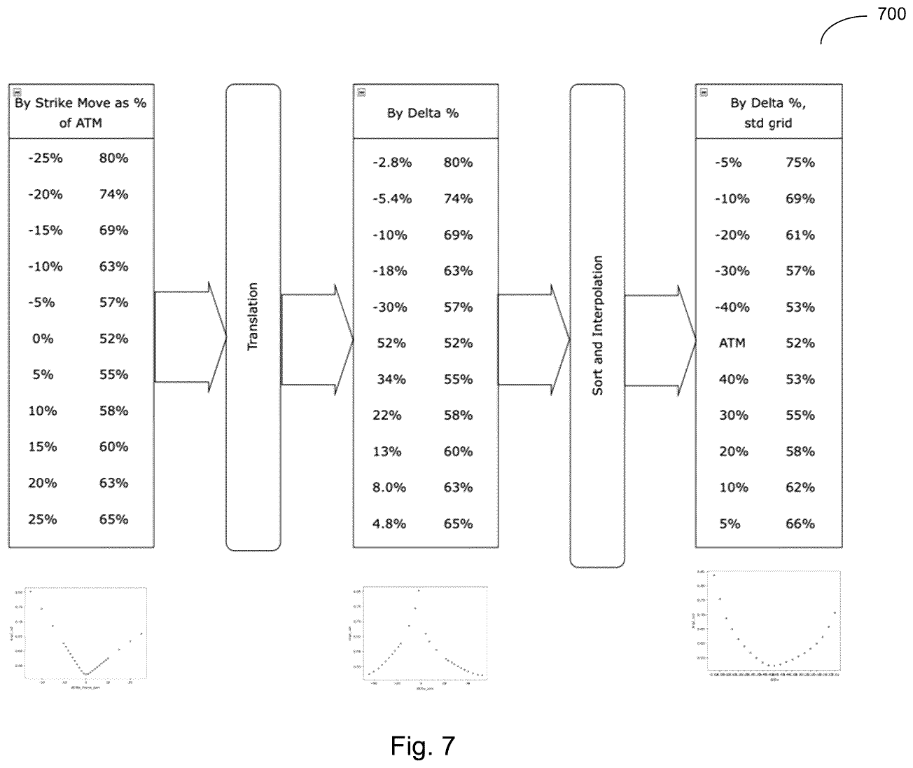

At block 288, the implied volatility surfaces (computed both for individual exchanges and for aggregated over exchanges) may be translated from the strike price-tenor space to delta-tenor space. Delta refers to the change of the price of a derivative product (e.g., option) upon a given change (e.g., one dollar) of the price of the underlying asset. As an option's delta is a function of both moneyness and implied volatility, the farther out-of-money (OTM) the option is or the lower the implied volatility, the smaller the absolute value of delta will be. However, implied volatilities of options that are far OTM are usually higher than those of options that are less OTM. As a result, a transformation of the implied volatilities from the strike price space to the delta space for a given tenor may be a non-monotonic transformation. In some implementations, this transformation may be obtained by (1) using individual fitted implied volatilities and the associated strike prices to translate the strike price grid into the corresponding deltas per tenor, (2) organizing original fitted implied volatilities in the order of corresponding decreasing deltas (negative deltas associated with OTM put options and positive deltas associated with OTM call options), and (3) performing the convexity and monotonicity validation check of the organized implied volatility points along the sorted delta-grid. If the validation fails, the exponential smoothing technique may then be applied to smooth the organized implied volatility points along the sorted delta-grid. FIG. 7 illustrates an example 700 of domain translation of implied volatility surfaces from the strike price-tenor space to delta-tenor space, in accordance with aspects of the present disclosure.

The implied volatility surface data may be organized into tables with fixed grids of tenors and moneyness, as described below. In some implementations, the output of the model may be delivered to a user via an API.

Interpolation of implied volatility may be performed on a certain chosen delta Δ in order to identify 1st and 2nd implied volatilities with deltas closest to the chosen delta, on either side of the chosen delta.

The interpolated volatility o is then constructed by linearly interpolating between the implied volatilities on those two deltas:

$$σ = \sqrt{( \frac{{Δ}_{2} - Δ}{{Δ}_{2} - {Δ}_{1}} ) {σ}_{1}^{2} + ( \frac{Δ - {Δ}_{1}}{{Δ}_{2} - {Δ}_{1}} ) {σ}_{2}^{2}} , where {Δ}_{1} < Δ < {Δ}_{2} .$$

For OTM puts, the interpolation range may be selected, e.g., from 0% to −50%.

For OTM calls, the interpolation range may be selected, e.g., from 50% to 0%.

The system may determine the x % stk-derived delta by the following operations:
a) getting put delta for the entire fitted implied volatility curve per tenor;
b) use each fitted implied volatilities and strike to translate strike-grid into put deltas per tenor;
c) sort all negative put deltas e^{-r(T-t)}(N(d₁)−1) in descending order from −0% delta to −100% delta;
d) replace all -deltas>−0.5 with positive call deltas e^{-r(T-t)}N(d₁) to complete the x % stk derived values for the deltas;
e) use the x % stk derived deltas to interpolate fixed %-delta volatilities;
f) for −50%-delta volatility, the system may extrapolate −50% dlt (from 2 most negative put_delta>−0.5);
g) for +50%-delta volatility, the system may extrapolate +50% dlt (from 2 most positive call_delta<+0.5);
h) compute atm %-delta volatility=(vol_extrapolated_−50% dlt+vol_extrapolated_+50% dlt)/2.

The system may then perform interpolation of implied volatility on a certain chosen time tₘ, by identifying two subsequent monthly expiration timestamps, which are 1st and 2nd closest to the point tₘ days, on either side of the tₘ days. The interpolated volatility σ may be constructed by linearly interpolating the square of the volatility between the expected variances from option prices on those two expiration timestamps:

$$σ = \sqrt{( {t}_{1} ( \frac{{t}_{2} - {t}_{m}^{′}}{{t}_{2} - {t}_{1}} ) {σ}_{1}^{2} + {t}_{2} ( \frac{{t}_{m}^{′} - {t}_{1}}{{t}_{2} - {t}_{1}} ) {σ}_{2}^{2} ) ( \frac{1}{{t}_{m}^{′}} )} ,$$

where
t₁ is the number of seconds to settlement of the closest near-term options prior to tₘ days;
t₂ is the number of seconds to settlement of the next-term options immediate after tₘ days;
t′ₘ is the number of seconds in tₘ days (t′ₘ=tₘ×86,400 see/day);

A risk-reversal (RR, synthetic long) position consists of long an OTM call and shorting an OTM put with the same moneyness level and expiry: (x %-delta risk-reversal)=(x %-delta call volatility)−(x %-delta put volatility), measuring the volatility skewness. The x %-delta skewness can be normalized as (x %-delta risk-reversal/ATM volatility) for comparison.

The ATM option's implied volatility is from a straddle involving buying a call and a put with the same ATM strike and expiry to achieve delta neutral. It's profitable when volatility increases.

A long (iron) butterfly (ironfly) strategy combines longing an OTM strangle (buying call and put with the same OTM level) and shorting an ATM straddle (selling ATM call and put) with the same expiry. It's profitable if future volatility is lower than the current implied volatility: (x %-delta butterfly)=(average of x %-delta call and put volatilities)−(ATM volatility).

Once the ATM volatility, x %-delta risk-reversal and butterfly are determined, the system may get an option's implied volatility with a delta which is not 50%. x %-delta option volatility can be derived from adjustments to ATM volatility capturing the volatility skewness: (x %-delta call volatility)=(ATM volatility)+0.5(x %-delta risk-reversal)+(x %-delta butterfly), and (x %-delta put volatility)=(ATM volatility)−0.5(x %-delta risk-reversal)+(x %-delta butterfly).

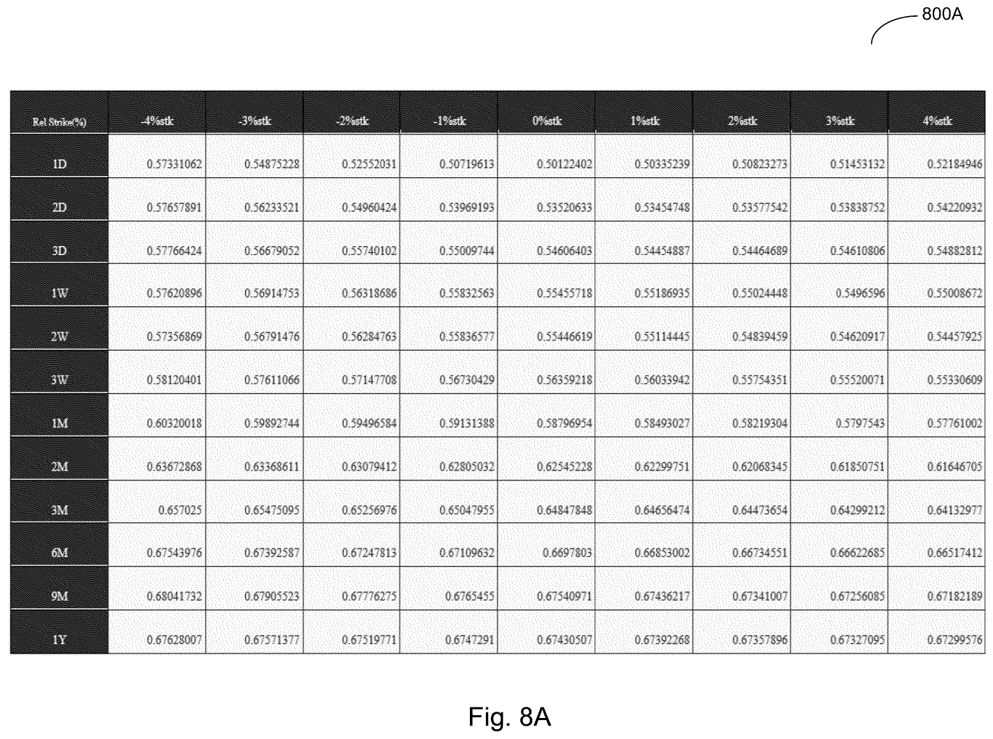

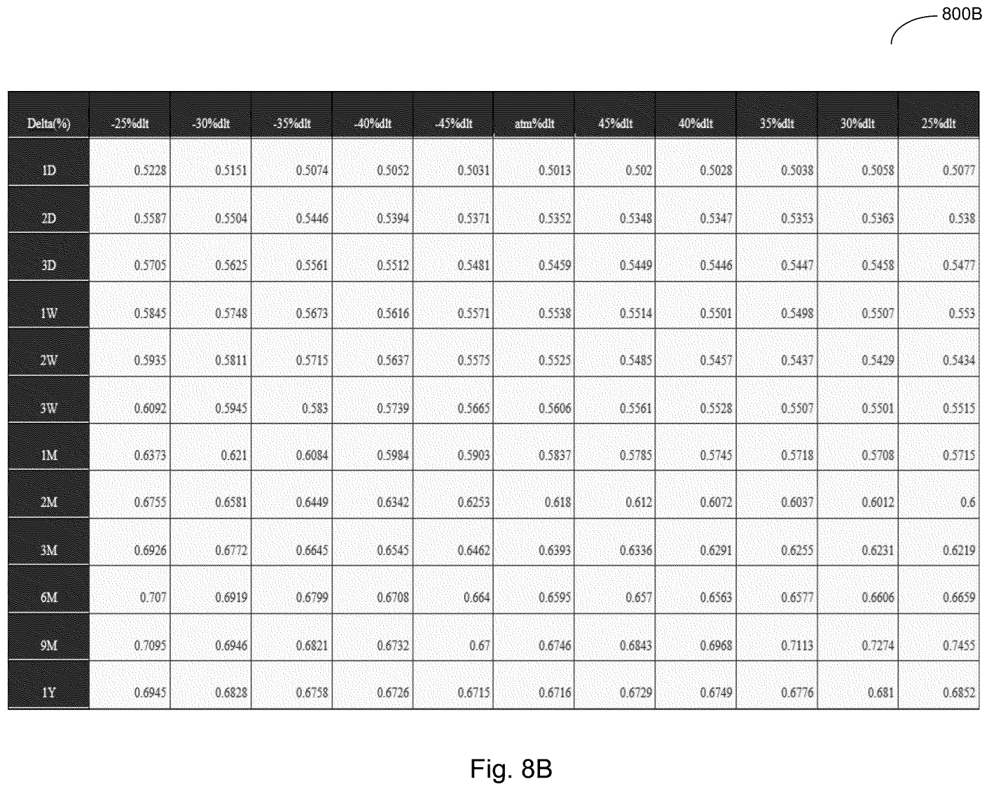

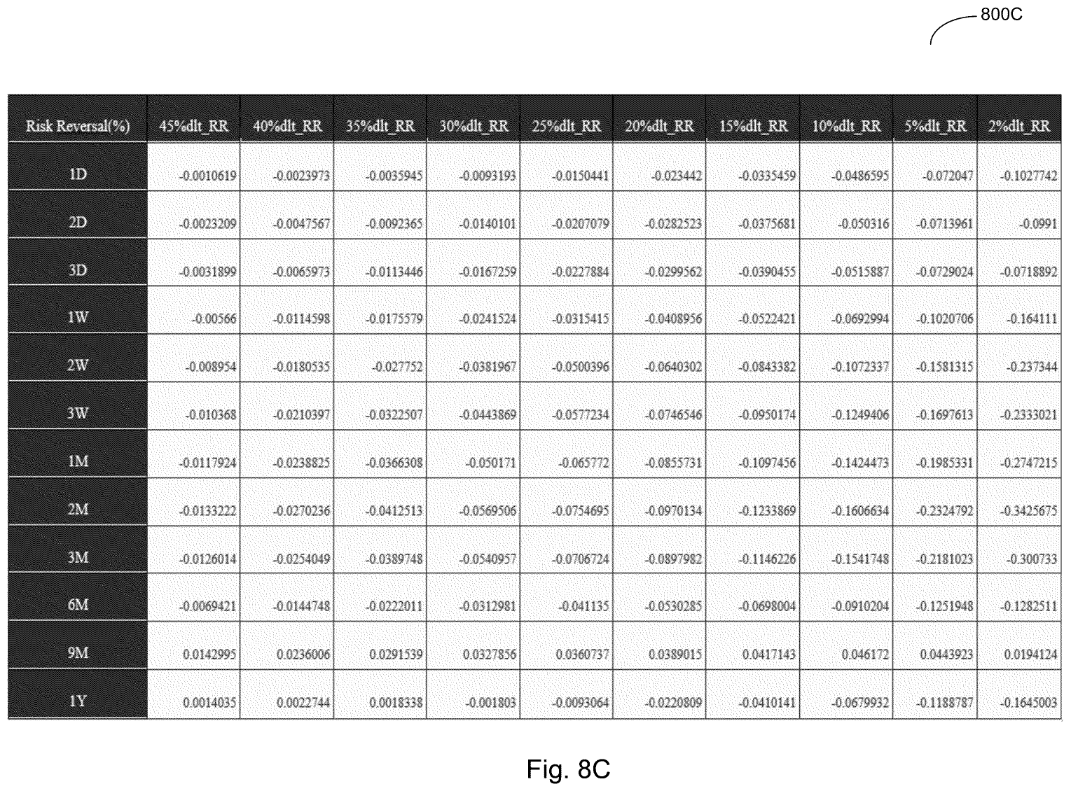

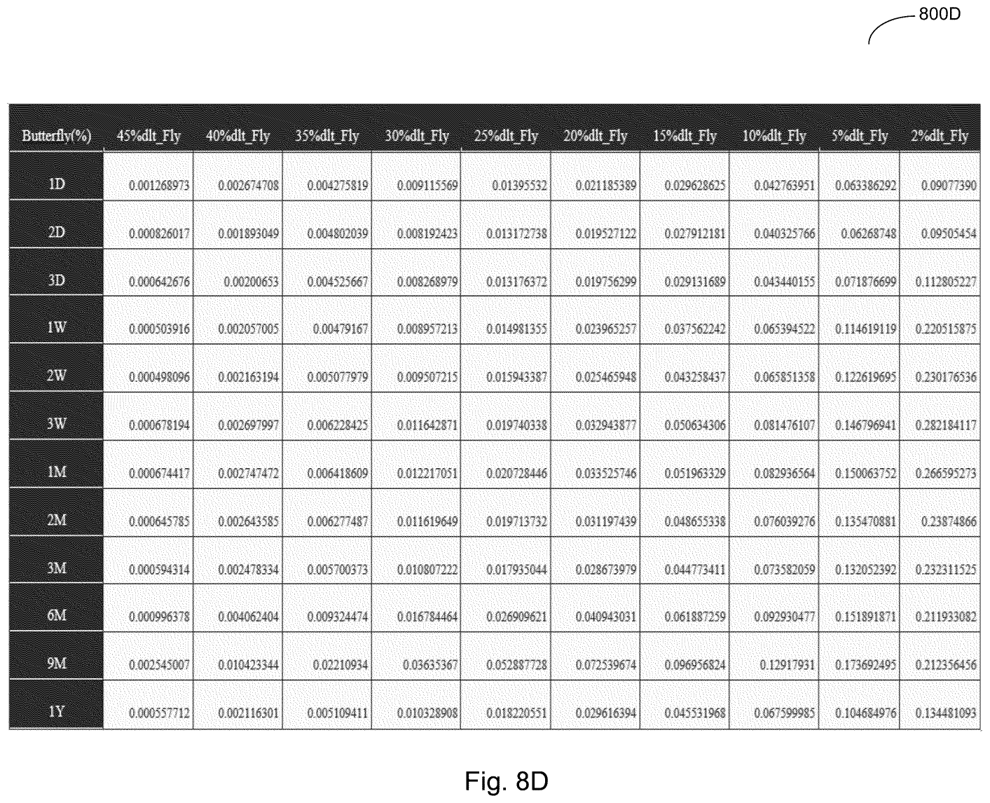

In an illustrative example, the implied volatility surface can be plotted or represented in a table form 800A over fixed tenors and relative strikes for a subset of the surface, as schematically illustrated by FIG. 8A.

In another illustrative example, the implied volatility surface can be plotted or represented in a table form 800B over fixed tenors and deltas for a subset of the surface, as schematically illustrated by FIG. 8B.

In another illustrative example, the Risk-Reversal (RR) can be plotted or represented in a table form 800C over fixed tenors, as schematically illustrated by FIG. 8C.

In another illustrative example, the Butterfly (Fly) can be plotted or represented in a table form 800D over fixed tenors, as schematically illustrated by FIG. 8D.

In order to ensure the complete full surface covering the prescribed strike range and tenor range, the following functional form may be used to perform the regression imputation of missing values:

$${σ}_{f i t t e d} ( \frac{{K}_{OTM}}{{K}_{ATM}} , T - t ) = e ( {a}_{0} + {b}_{1} ( \frac{{K}_{OTM}}{{K}_{ATM}} ) + {b}_{2} ( T - t ) ) + ε$$

The estimated parameters are calibrated using the log-linear transformation

$$log ( {σ}_{f i t t e d} ( \frac{{K}_{OTM}}{{K}_{ATM}} , T - t ) ) = {a}_{0} + {b}_{1} ( \frac{{K}_{OTM}}{{K}_{ATM}} ) + {b}_{2} ( T - t ) + log ( ε )$$

to minimize the sum of squared residuals between the log of fitted OTM volatilities and the values from the log-linear transformation. Taking into consideration that implied volatilities can exhibit sudden high value spikes and can be approximately multiplicative lognormal, the log-transformed linear regression is preferred over the Nonlinear Least Squares (NLS) regression assuming additive normal errors.

For empty tenors without any fitted values mainly due to no data, both regression imputation and extrapolation along tenors are not used. Filling an empty tenor using extrapolation along tenors might cause convexity violation especially when some strikes exhibit downward sloping term structure. Empty tenors may be treated in the following way. If there is no non-empty tenor before an empty tenor, then the empty tenor may be flat-filled by copying over the closest longer-term non-empty tenor. If there is no non-empty tenor after an empty tenor, the empty tenor may be flat-filled by copying over the closest shorter-term non-empty tenor. If an empty tenor lies between non-empty tenors, the empty tenor may be interpolated with two adjacent non-empty tenors before and after it.

For each as-of-time, 2 regressions may be performed to obtain 2 sets of estimates {a₀,b₁,b₂}. One regression may be from the OTM put side fitted values, and another regression may be from the OTM call side fitted values.

Predicted put surface: After obtaining the {a₀,b₁,b₂} estimates based on the OTM put side fitted values, the entire surface can be populated based on the OTM put side estimated parameters. The surface is downward sloping from the OTM put side towards the ITM put side. Predicted call surface: after obtaining the {a₀,b₁,b₂} estimates based on the OTM call side fitted values, we can populate the entire surface based OTM call side estimated parameters. It is upward sloping from the ITM call side towards the OTM call side.

Predictions from the predicted put surface can be used to fill NANs for the OTM puts side of the original fitted surface with NANs. Predictions from the predicted call surface can be used to fill NANs for the OTM call side of the original fitted surface with NANs. There are no missing fitted values around ATM region for non-empty tenors.

The filled predicted implied volatilities for each wing per tenor are capped at minimum(maximum(maximum of original fitted SVI implied volatilities, predicted imputation values), MUB) for the OTM put side and the OTM call side, respectively.

If there are any NANs filled by flat values after capping for a certain wing (OTM put side or OTM call side) for a certain tenor, then exponential smoothing is applied to further smooth the curve.

$${σ}_{s m o o t h e d , n + 1} = α {σ}_{f i t t e d , n} + ( 1 - α ) {σ}_{s m o o t h e d , n} = α {σ}_{f i t t e d , n} + ( 1 - α ) ( α {σ}_{f i t t e d , n - 1} + ( 1 - α ) {σ}_{s m o o t h e d , n - 1} ) = α {\sum }_{i = 0}^{n} ( {( 1 - α )}^{n - i} {σ}_{fitted , i} )$$

The smooth level α ranges [0, 1]. The above derivation shows that the lower the a, the more weights distributed through past values, and the more smooth is the resulting curve.

The exponential smoothing may be applied on decreasing values. The order of fitted implied volatilities on the OTM put side is fine having decreasing values along the increasing strikes. But for the OTM call side, the order needs to get reversed before applying the exponential smoothing on decreasing values along the decreasing strikes.

In some implementations, the following automated validations of data quality and controls may be utilized by the system for construction of implied volatility surfaces:
ensure that the fitted implied volatility surface is positive;
validate the convexity of the fitted implied volatility curve along the moneyness-axis per expiry;
ensure that the saved calibrated parameters yield the fitted implied volatilities close to the observed implied volatilities around ATM per expiry;
ensure that the fitted implied volatility curve along the delta-axis is smooth across the ATM range per expiry;
ensure that those fitted implied volatilities above the UB are set to NAN and then are filled by regression imputation;
ensure that the fitted implied volatility surface covers all tenors that an exchange has offered option contracts. If there is a missing curve after regression imputation that might be due to no data for fitting, then the previous valid fitted curve is filled forward;
validate risk reversal and butterfly values that are generated along the delta-axis.

In some implementations, the computing system may implement the SVI parameterization approach in order to produce not only fitted implied volatility surface data based on an individual exchange's cryptoasset option contracts, but also aggregated implied volatility surface data of a certain underlying cryptoasset based on aggregating trade level implied volatilities across exchanges.

For each tenor, there may be more trade level implied volatilities for each moneyness that can be aggregated across exchanges due to the fragmented nature of the cryptoasset ecosystem. However, trade level implied volatilities of the same moneyness from different exchanges may have different reliability and thus should not be counted equally. Accordingly, the system can use time-decayed weighted trade level implied volatilities to construct aggregate trade level implied volatilities for each moneyness per tenor. Then the system can fit the SVI implied volatility surface over those aggregated trade level implied volatilities.

At each strike per tenor, the following equation shows the aggregate trade level implied volatility σ_{agg}(t) at the as-of time t assuming there are N exchanges that we can collect their last trade-level implied volatilities σ(tᵢ) prior to t within a specified past time window τ, which may be set to past one day:

$${σ}_{agg} ( t ) = {\sum }_{i = 1}^{N} ( {w}_{i} ( t - {t}_{i} ) * σ ( t - {t}_{i} ) ) τ \leq {t}_{i} \leq t$$

Where the weighting scheme wᵢ(t−tᵢ) is based on an exponential time decay function ƒᵢ(t−tᵢ) decaying by seconds within a day, and all weights will sum up to 1;

$$\begin{matrix}{f}_{i} ( t - {t}_{i} ) = {e}^{- λ ( \frac{t - {t}_{i}}{86400} )} \\ {w}_{i} ( t - {t}_{i} ) = \frac{{f}_{i} ( t - {t}_{i} )}{{\sum }_{i = 1}^{N} ( {f}_{i} ( t - {t}_{i} ) )}\end{matrix}$$

Larger λ make makes the decaying quantity vanish much more rapidly. Using a half-life parameter h to specify the amount of time relative to the total time window that the decaying quantity will be cut in half would allow setting

$$λ = \frac{ln ( 2 )}{h} .$$

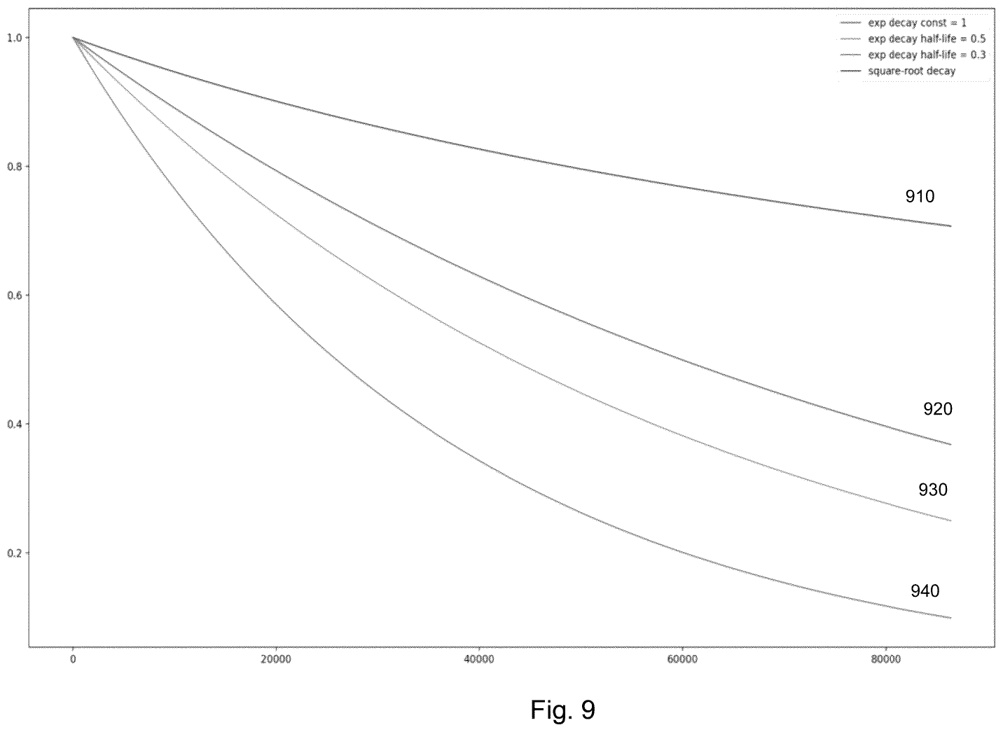

Therefore, setting λ to 1 is equivalent to setting h=ln(2)=0.693, which is about 17 hours. Thus, the shorter the half-life is, the faster the decay is, as schematically illustrated by FIG. 9, in which plot 910 corresponds to the square root decay, plot 920 corresponds to exponential decay with λ=1, plot 930 corresponds to exponential decay with half-life=0.9, and plot 940 corresponds to exponential decay with half-life=0.3.

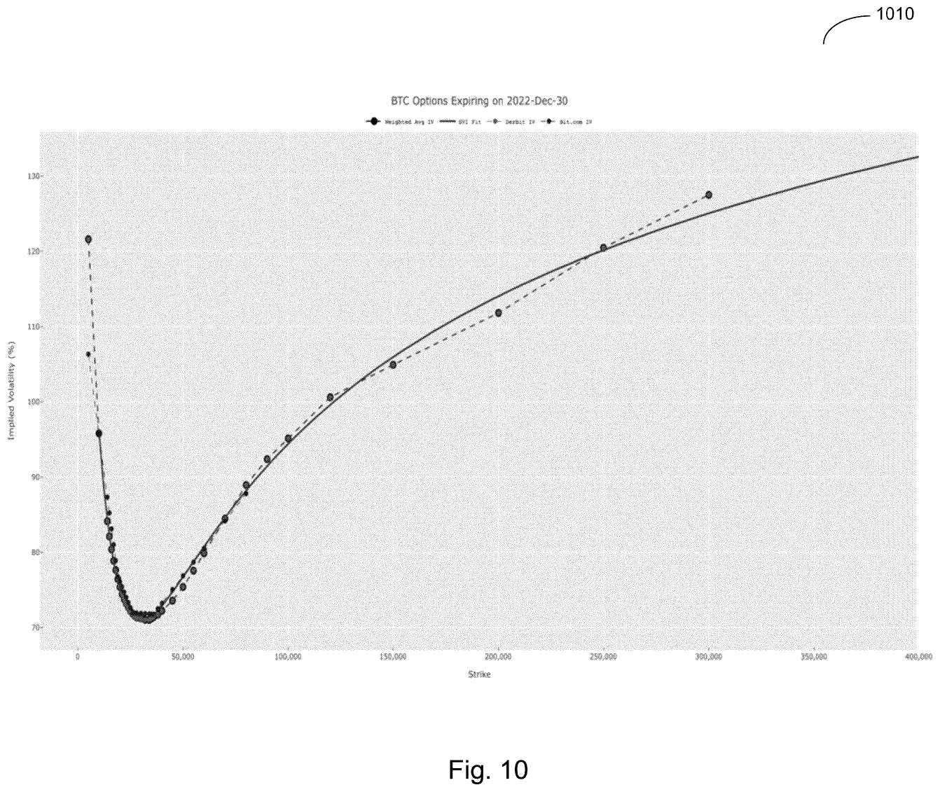

In effect, the above-described weighting scheme implements a signal-to-noise enhancement, delegating more weight to those exchanges with more information content (such as timeliness with low latency). This serves to diminish the effects of outliers without dropping data. The aggregation simulates a smoothed signal extractor. This is schematically illustrated by FIG. 10, in which plot 1010 shows the SVI fitted curve output over the weighted implied volatilities (black dots) from two exchanges with respect to the strike axis.

Thus, the aggregate implied volatility surfaces are fitted based on the aggregate trade level implied volatilities. The trade level implied volatilities utilize time decay to take into account staleness. Furthermore, the weighting scheme for aggregation can be enhanced to take into account the effects of liquidity (such as open interest and volume), certain exchange scores and other potential contributions. For example, the weighting scheme wᵢ(tᵢ,mᵢ,sᵢ) can be based on the function ƒᵢ(tᵢ,mᵢ,sᵢ) where tᵢ is the timestamp of the top-order book mid-price, mᵢ is the average (size*multiplier) over the past 24 hours, s; is the (best ask price−best bid price) with a lower bound of 0.0001. All weights will sum up to 1.

$$\begin{matrix}f ( {t}_{i} , {m}_{i} , {s}_{i} ) = {( {e}^{- λ ( \frac{t - {t}_{i}}{86400} )} ( \frac{{m}_{i}}{{\sum }_{i = 1}^{N} {m}_{i}} ) ( \frac{{s}_{i}^{- 1}}{{\sum }_{i = 1}^{N} {s}_{i}^{- 1}} ) )}^{\frac{1}{3}} \\ {w}_{i} ( {t}_{i} , {m}_{i} , {s}_{i} ) = \frac{{f}_{i} ( {t}_{i} , {m}_{i} , {s}_{i} )}{{\sum }_{i = 1}^{N} ( {f}_{i} ( {t}_{i} , {m}_{i} , {s}_{i} ) )}\end{matrix}$$

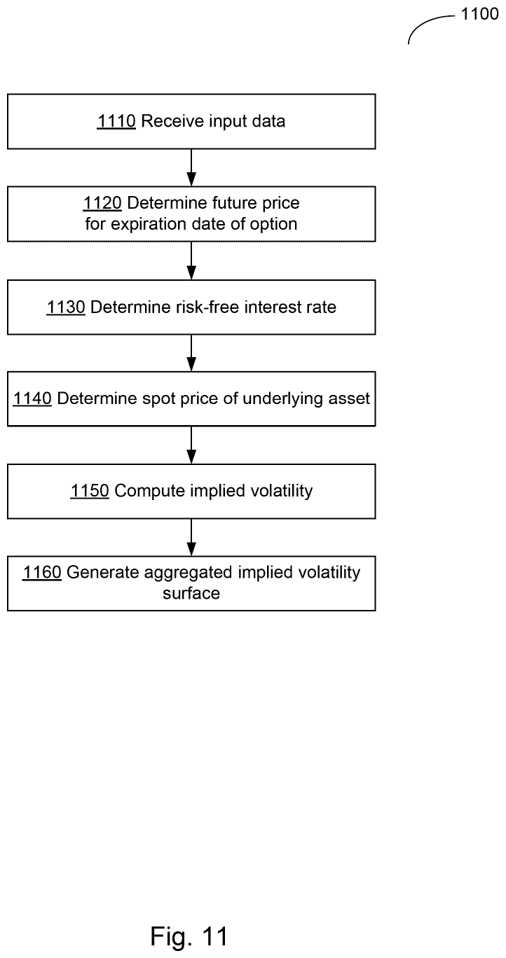

FIG. 11 is a flowchart of a method 1100 of computing implied volatilities for cryptoasset options, in accordance with some embodiments of the present disclosure. Method 1100 and/or each of its individual functions, routines, subroutines, or operations may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, method 1100 may implement one or more operations of workflows 200A and/or 200B.

In some implementations, method 1100 may be performed by one or more processors of the example computing system 100 of FIG. 1. In some implementations, method 1100 may be performed by a single processing thread. Alternatively, method 1100 may be performed by two or more processing threads, each thread executing one or more individual functions, routines, subroutines, or operations of the method. In an illustrative example, the processing threads implementing method 1100 may be synchronized (e.g., using semaphores, critical sections, and/or other thread synchronization mechanisms). Alternatively, the processing threads implementing method 1100 may be executed asynchronously with respect to each other. Although shown in a particular sequence or order, unless otherwise specified, the order of the operations may be modified. Additionally, one or more operations may be omitted in various implementations.

At operation 1110, the computing system implementing the method receives, from one or more exchanges, input data, which can include transaction data characterizing a trade in an option of a specified cryptoasset and/or quote data for an option of a specified cryptoasset. The transaction data and/or quote data may comprise an identifier of an underlying asset, a type of the option, an expiration time of the option, an as-of time of the input data, and a price of the option, as described in more detail herein above. In some implementations, the computing system may retrieve the transaction data from the normalized transaction database 235 of FIG. 2 and/or normalized transaction cache 238 of FIG. 2. In some implementations, the computing system may retrieve the quote data from the reference database 245 of FIG. 2. In an illustrative example, the computing system may retrieve and process the transaction data from the normalized transaction cache before switching to the non-cached transaction data stored in the normalized transaction database 235, thus forcing the computed implied rates to be biased towards the normalized transaction records that have been selected for caching (e.g., transaction records reported by a predefined one or more reference exchanges with respect to a predefined set of underlying cryptoasset), as described in more detail herein above.

At operation 1120, the computing system determines a future price for the expiration time of the option based on future prices of two or more futures having their respective expiration timestamps closest to the expiration time of the option, as described in more detail herein above.

At operation 1130, the computing system determines a risk-free interest rate associated with the expiration time of the option and the as-of time of the input data, as described in more detail herein above.

At operation 1140, the computing system determines a spot price of the underlying asset at the as-of time of the trade or quote data, as described in more detail herein above.

At operation 1150, the computing system computes, based on the input data, the future price, the risk-free interest rate, and the spot price, an implied volatility of a price of the option, as described in more detail herein above. The operations 1110-1150 may be performed for each of multiple transaction records received by the computing system.

At operation 1160, the computing system generates, based on the input data, an aggregated implied volatility surface of a specified cryptoasset using a plurality of aggregated trade level implied volatilities of the specified cryptoasset, as described in more detail herein above.

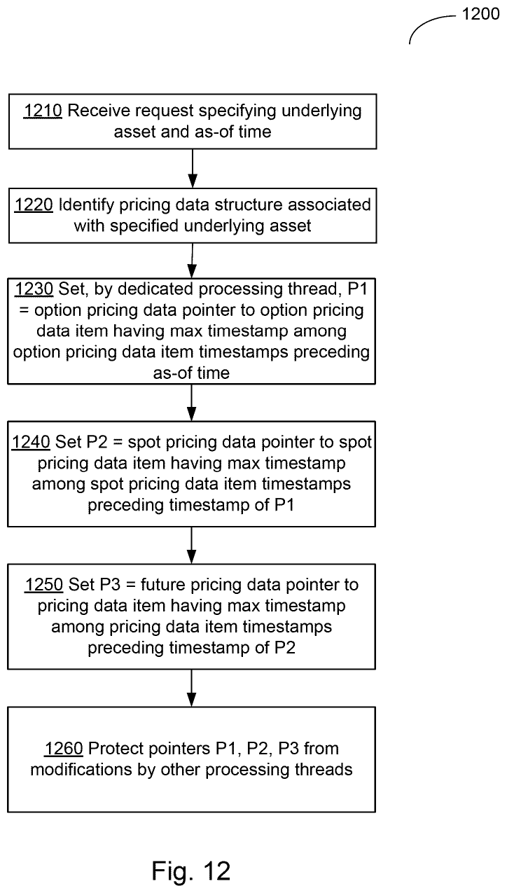

FIG. 12 is a flowchart of a method 1200 of managing a pricing data structure, in accordance with some embodiments of the present disclosure. Method 1200 and/or each of its individual functions, routines, subroutines, or operations may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, method 1200 may implement one or more operations of workflows 200A and/or 200B.

In some implementations, method 1200 may be performed by one or more processors of the example computing system 100 of FIG. 1. In some implementations, method 1200 may be performed by a single dedicated processing thread. Alternatively, method 1200 may be performed by two or more processing threads, each thread executing one or more individual functions, routines, subroutines, or operations of the method. In an illustrative example, the processing threads implementing method 1200 may be synchronized (e.g., using semaphores, critical sections, and/or other thread synchronization mechanisms). Alternatively, the processing threads implementing method 1200 may be executed asynchronously with respect to each other. Although shown in a particular sequence or order, unless otherwise specified, the order of the operations may be modified. Additionally, one or more operations may be omitted in various implementations.

At operation 1210, the computing system implementing the method receives a data retrieval request specifying a reference time (e.g., as-of time) and an underlying asset.

At operation 1220, the computing system identifies the pricing data structure (e.g., data structure 500 of FIG. 5) for the underlying asset specified by the request.

At operation 1230, the computing system sets the option pricing data pointer associated with the identified pricing data structure to reference the option pricing data item having the maximum timestamp among option pricing data items whose timestamps precede the specified as-of time.

At operation 1240, the computing system sets the spot pricing data pointer associated with the identified pricing data structure to reference the spot pricing data item having the maximum timestamp among spot pricing data items whose timestamps precede the timestamp of the option pricing data item referenced by the option pricing data pointer.

At operation 1250, the computing system sets the future pricing data pointer associated with the identified pricing data structure to reference the future pricing data item having the maximum timestamp among future pricing data items whose timestamps precede the timestamp of the spot pricing data item referenced by the spot pricing data pointer.

At operation 1260, the computing system protects the pointers from being modified by any processing threads other than the processing thread(s) that has set the pointers in operations 1230-1250. In some implementations, the pointers may be implemented by respective private variables of a software module managing the pricing data structure 500 and running as a dedicated processing thread, such that the pointers may not be directly accessed by any other software modules. Upon request from other processing threads and/or software modules (e.g., from the processing thread implementing the operation 270 of workflows 200A-200B), the software module managing the pricing data structure 500 would return a data items referenced by a specified pointer, thus protecting the pricing data structure 500 and the associated pointers from being modified by any other processing threads.

FIG. 13 illustrates an example machine of a computing system 1300 within which a set of instructions, for causing the machine to perform any one or more of the methods discussed herein, may be executed. In some embodiments, the computing system 1300 may be a computing device that includes a processor with a cache controller, a memory controller, or combination thereof. In alternative embodiments, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methods discussed herein.

The example computing system 1300 includes a processing device 1302 (e.g., Processor 122), a main memory 1304 (e.g., read-only memory (ROM), flash memory, dynamic random access memory (DRAM) such as synchronous DRAM (SDRAM), etc.), a static memory 1308 (e.g., flash memory, static random access memory (SRAM), etc.), and a data storage system 1318, which communicate with each other via a bus 1330.

Processing device 1302 may represent one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1302 may also be one or more special-purpose processing devices such as an application specific integrated circuit (ASIC), a field programmable gate array (FPGA), a digital signal processor (DSP), network processor, bus controller, peripheral device controller, or the like. The processing device 1302 is configured to execute instructions 1328 for performing the operations and steps discussed herein. The computing system 1300 may further include a network interface device 1308 to communicate over the network 1320.

The data storage system 1318 may include a machine-readable storage medium 1324 (also known as a non-transitory computer-readable medium) on which is stored one or more sets of instructions 1328 or software embodying any one or more of the methods or functions described herein. The instructions 1328 may also reside, completely or at least partially, within the main memory 1304 and/or within the processing device 1302 during execution thereof by the computing system 1300, the main memory 1304 and the processing device 1302 also constituting machine-readable storage media. In one embodiment, the instructions 1328 include instructions to the method 1100 of computing implied volatilities of cryptoasset options and/or method 1200 of managing pricing data structures in accordance with aspects of the present disclosure.

While the machine-readable storage medium 1324 is shown in an example embodiment to be a single medium, the term “non-transitory machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methods of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure may refer to the action and processes of a computing system, or similar electronic computing device, that manipulates and transforms data represented as physical (electronic) quantities within the computing system's registers and memories into other data similarly represented as physical quantities within the computing system memories or registers or other such information storage systems.

The present disclosure also relates to an apparatus for performing the operations herein. This apparatus may be specially constructed for the intended purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computing system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computing system (or other electronic devices) to perform a process according to the present disclosure. A machine-readable medium includes any mechanism for storing information in a form readable by a machine (e.g., a computer). In some embodiments, a machine-readable (e.g., non-transitory computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications may be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving, by a processing device, input data comprising at least one of: transaction data characterizing a trade in an option of a specified cryptoasset or a quote for the option of the specified cryptoasset, wherein the input data comprises an identifier of an underlying asset, a type of the option, an expiration time of the option, an as-of time of the input data, and a price of the option;
estimating a future price for the expiration time of the option;
determining a risk-free interest rate associated with the expiration time of the option and the as-of time of the input data;
determining a spot price of the underlying asset at the as-of time of the input data; and
computing, based on the input data, the future price, the risk-free interest rate, and the spot price, an implied volatility of a price of the option.

2. The method of claim 1, wherein estimating the future price for the expiration time of the option is performed based on prices of one or more futures having their respective expiration timestamps closest to the expiration time of the option.

3. The method of claim 1, wherein estimating the future price for the expiration time of the option is performed based on a spot price of the underlying asset and prices of one or more futures having their respective expiration timestamps at or above the expiration time of the option.

4. The method of claim 1, further comprising:
generating, based on the input data, an aggregated implied volatility surface of a specified cryptoasset using a plurality of aggregated trade level implied volatilities of the specified cryptoasset.

5. The method of claim 1, further comprising:
transforming the aggregated implied volatility surface of the specified cryptoasset to a delta-tenor space.

6. The method of claim 1, further comprising:
verifying that a timestamp associated with the price of the option does not exceed the as-of time of the input data.

7. The method of claim 1, further comprising:
verifying that a first timestamp associated with the price of the option does not precede a second timestamp associated with a converted to fiat price of the option.

8. The method of claim 1, further comprising:
verifying that a first timestamp associated with the price of the option does not precede a second timestamp associated with a listed futures timestamp.

9. The method of claim 1, further comprising:
determining, based on the computed implied volatility of the price of the option, a price of the option for a chosen time that is prior to the as-of time of the input data; and
comparing the computed price of the option with a known price of the option for the chosen time.

10. The method of claim 1, wherein determining the future price based on future prices of the two or more futures is performed responsive to determining that no futures data with respect to the specified cryptoasset is available for the expiration time of the option.

11. The method of claim 1, further comprising:
storing the trading data in a pricing data structure associated with the underlying cryptoasset, the pricing data structure comprising an option pricing data queue associated with an option pricing data pointer, an underlying cryptoasset spot pricing data queue associated with a spot pricing data pointer, and a future pricing data queue associated with a future option pricing data pointer;
synchronizing, by a dedicated processing thread, the option pricing data pointer, the spot pricing data pointer, and the future pricing data pointer with the as-of time;
protecting the option pricing data pointer, the spot pricing data pointer, and the future pricing data pointer from being modified by other processing threads; and
retrieving a reference pricing data set comprising pricing data items referenced by respective synchronized option pricing data pointer, spot pricing data pointer, and future pricing data pointer.

12. The method of claim 11, wherein the pricing data structure is at least partially cached in a random access memory (RAM) buffer, and wherein a size of the RAM buffer is dynamically adjusted to reflect a trading volume of the underlying cryptoasset over a certain period of time at one or more reference exchanges.

13. A system comprising:
a memory;
a processing device, communicably coupled to the memory, the processing device configured to:
receive input data comprising at least one of: transaction data characterizing a trade in an option of a specified cryptoasset or a quote for the option of the specified cryptoasset, wherein the input data comprises an identifier of an underlying asset, a type of the option, an expiration time of the option, an as-of time of the input data, and a price of the option;
estimate a future price for the expiration time of the option;
determine a risk-free interest rate associated with the expiration time of the option and the as-of time of the input data;
determine a spot price of the underlying asset at the as-of time of the input data; and
compute, based on the input data, the future price, the risk-free interest rate, and the spot price, an implied volatility of a price of the option.

14. The system of claim 13, wherein the processing device is further configured to:
generate an aggregated implied volatility surface of a specified cryptoasset using a plurality of aggregated trade level implied volatilities of the specified cryptoasset based on input data received from one or more exchanges.

15. The system of claim 13, wherein the processing device is further configured to:
store the trading data in a pricing data structure associated with the underlying cryptoasset, the pricing data structure comprising an option pricing data queue associated with an option pricing data pointer, an underlying cryptoasset spot pricing data queue associated with a spot pricing data pointer, and a future pricing data queue associated with a future option pricing data pointer;
synchronize, by a dedicated processing thread, the option pricing data pointer, the spot pricing data pointer, and the future pricing data pointer with the as-of time;
protect the option pricing data pointer, the spot pricing data pointer, and the future pricing data pointer from being modified by other processing threads; and
retrieve a reference pricing data set comprising pricing data items referenced by respective synchronized option pricing data pointer, spot pricing data pointer, and future pricing data pointer.

16. The system of claim 15, wherein the pricing data structure is at least partially cached in a random access memory (RAM) buffer, and wherein a size of the RAM buffer is dynamically adjusted to reflect a trading volume of the underlying cryptoasset over a certain period of time at one or more reference exchanges.

17. A non-transitory machine-readable storage medium comprising executable instructions which, when executed by a computing system, cause the computing system to:
receive input data comprising at least one of: transaction data characterizing a trade in an option of a specified cryptoasset or a quote for the option of the specified cryptoasset, wherein the input data comprises an identifier of an underlying asset, a type of the option, an expiration time of the option, an as-of time of the input data, and a price of the option;
estimate a future price for the expiration time of the option;
determine a risk-free interest rate associated with the expiration time of the option and the as-of time of the input data;
determine a spot price of the underlying asset at the as-of time of the input data; and
compute, based on the input data, the future price, the risk-free interest rate, and the spot price, an implied volatility of a price of the option.

18. The non-transitory machine-readable storage medium of claim 17, further comprising executable instructions which, when executed by the computing system, cause the computing system to:
generating an aggregated implied volatility surface of a specified cryptoasset using a plurality of aggregated trade level implied volatilities of the specified cryptoasset based on input data received from one or more exchanges.

19. The non-transitory machine-readable storage medium of claim 17, further comprising executable instructions which, when executed by the computing system, cause the computing system to:
store the trading data in a pricing data structure associated with the underlying cryptoasset, the pricing data structure comprising an option pricing data queue associated with an option pricing data pointer, an underlying cryptoasset spot pricing data queue associated with a spot pricing data pointer, and a future pricing data queue associated with a future option pricing data pointer;
synchronize, by a dedicated processing thread, the option pricing data pointer, the spot pricing data pointer, and the future pricing data pointer with the as-of time;
protect the option pricing data pointer, the spot pricing data pointer, and the future pricing data pointer from being modified by other processing threads; and
retrieve a reference pricing data set comprising pricing data items referenced by respective synchronized option pricing data pointer, spot pricing data pointer, and future pricing data pointer.

20. The non-transitory machine-readable storage medium of claim 19, wherein the pricing data structure is at least partially cached in a random access memory (RAM) buffer, and wherein a size of the RAM buffer is dynamically adjusted to reflect a trading volume of the underlying cryptoasset over a certain period of time at one or more reference exchanges.
